(19) United States
(12) Patent Application Publication
(10) Pub. No.: US 2008/0125949 A1
(43) Pub. Date: May 29, 2008

(54) Method for Operating a Motor Vehicle

(75) Inventor: Goetz Richter, Muhlacker (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/944,704

(22) Filed: Nov. 26, 2007

(30) Foreign Application Priority Data
Nov. 25, 2006 (DE) 10 2006 055 722.0

(51) Int. Cl. B60W 30/16

(52) U.S. Cl. 701/96

(57) ABSTRACT

In a method for operating a motor vehicle, the actual distance of the vehicle that is to be operated from a vehicle driving in front of the vehicle that is to be operated is detected, and the speed of the vehicle that is to be operated is influenced automatically such that a predetermined setpoint distance is maintained. Accordingly, the distance of the vehicle that is to be operated from a vehicle driving behind the vehicle that is to be operated is additionally detected. When the distance of the vehicle that is to be operated from the vehicle driving behind the vehicle that is to be operated drops below a specific limit value, the predetermined setpoint distance of the vehicle that is to be operated from the vehicle driving in front of the vehicle that is to be operated is automatically increased or the speed of the vehicle that is to be operated is automatically influenced such that the actual distance is increased in deviation from the predetermined setpoint distance.

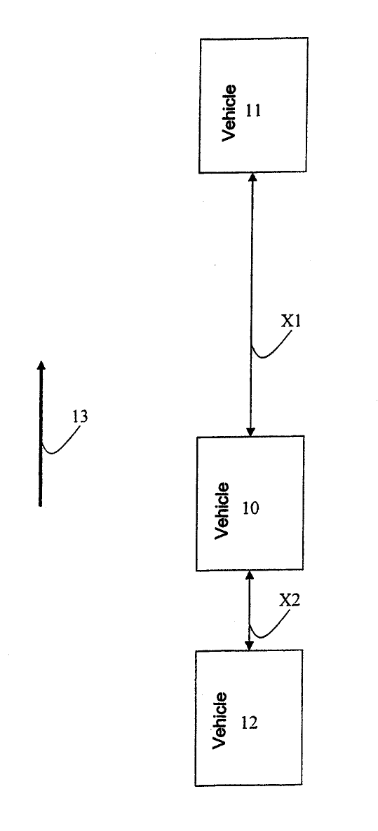

### CROSS-REFERENCE TO RELATED APPLICATION

This application claims the priority, under 35 U.S.C. § 119, of German application DE 10 2006 055 722.0, filed Nov. 25, 2006; the prior application is herewith incorporated by reference in its entirety.

### BACKGROUND OF THE INVENTION

### Field of the Invention

The invention relates to a method for operating a motor vehicle in which the actual distance of the vehicle that is to be operated from a vehicle driving in front of the vehicle that is to be operated is detected, and the speed of the vehicle that is to be operated is influenced automatically such that a predetermined setpoint distance is maintained.

Vehicles having so-called adaptive cruise control (ACC) are already known. Vehicles having adaptive cruise control are operated so that the actual distance of a vehicle that is to be operated from a vehicle driving in front of the vehicle that is to be operated is detected, and the speed of the vehicle that is to be operated is influenced automatically in such a way that a predetermined setpoint distance is maintained. The predetermined setpoint distance preferably depends on the speed in order to ensure an adequate safety distance from the vehicle driving in front of the vehicle that is to be operated at all speeds of the vehicle that is to be operated.

Published, non-prosecuted German patent application DE 103 28 755 A1 describes a method for operating a vehicle, wherein the distance of the vehicle that is to be operated from a vehicle driving behind the vehicle that is to be operated is detected, and then when this distance drops below a minimum distance, measures are taken to prevent a further reduction in distance. Typically the speed of the vehicle that is to be operated is therefore then increased, but this necessarily reduces the actual distance from the vehicle driving in front of the vehicle that is to be operated.

### BRIEF SUMMARY OF THE INVENTION

It is accordingly an object of the invention to provide a method for operating a motor vehicle that overcomes the above-mentioned disadvantages of the prior art methods of this general type.

With the foregoing and other objects in view there is provided, in accordance with the invention, a method for operating a motor vehicle. The method includes the steps of detecting an actual distance of the motor vehicle being operated from a further vehicle driving in front of the motor vehicle being operated; automatically influencing a speed of the motor vehicle being operated such that a predetermined setpoint distance is maintained; and detecting a further distance of the motor vehicle being operated from an additional vehicle driving behind the motor vehicle being operated. If the further distance of the motor vehicle being operated from the additional vehicle driving behind the motor vehicle being operated drops below a specific limit value, automatically increasing the predetermined setpoint distance of the motor vehicle being operated from the further vehicle driving in front of the motor vehicle being operated.

According to this invention, the distance of the vehicle that is to be operated from a vehicle driving behind the vehicle that is to be operated is additionally detected, and then when the distance between the vehicle that is to be operated and the vehicle driving behind the vehicle that is to be operated drops below a specific limit value, the predetermined setpoint distance of the vehicle that is to be operated from the vehicle driving in front of the vehicle that is to be operated is automatically increased or the speed of the vehicle that is to be operated is automatically influenced in such a way that the actual distance is increased in deviation from the predetermined setpoint distance.

In the sense of the present invention, it is proposed that when the distance between the vehicle that is to be operated and the vehicle driving behind the vehicle that is to be operated drops below a specific limit value, measures are taken so that the actual distance from the vehicle driving in front of the vehicle that is to be operated is increased. Therefore the speed of the vehicle that is to be operated is reduced. In this way, the safety distance of the vehicle that is to be operated from the vehicle driving in front is increased by an amount by which the safety distance of the vehicle driving behind from the vehicle that is to be operated is too low. Only in this way is it possible to reliably avoid dangerous driving situations.

At the latest when the distance of the vehicle that is to be operated from the vehicle driving behind the vehicle that is to be operated drops below the specific limit value, brake lights of the vehicle that is to be operated are preferably activated automatically.

Other features which are considered as characteristic for the invention are set forth in the appended claims.

Although the invention is illustrated and described herein as embodied in a method for operating a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is an illustration of car distances for understanding the method according to the invention.

### DETAILED DESCRIPTION OF THE INVENTION

The inventive method for operating a vehicle is described in greater detail below with reference to the FIGURE of the drawing. The FIGURE of the drawing shows a vehicle 10 that is to be operated, a vehicle 11 driving in front of the vehicle 10 that is to be operated and a vehicle 12 driving behind the vehicle 10 that is to be operated. The direction of travel of the vehicle that is to be operated thus corresponds to the arrow 13.

In the sense of the present invention, an actual distance X1 of the vehicle 10 that is to be operated from the vehicle 11 driving in front of the vehicle 10 that is to be operated is detected, and the speed of the vehicle that is to be operated is automatically influenced in such a way that a predetermined setpoint distance, preferably depending on speed, is maintained for the distance X1.

In addition, a distance X2 of the vehicle 10 that is to be operated from a vehicle 12 driving behind the vehicle 10 that is to be operated is detected according to the invention, and when the distance X2 drops below a specific limit value, measures are initiated so that the actual distance X1 from the vehicle 11 driving in front is increased.

To do so, either the predetermined setpoint distance for X1 may be increased or the speed of the vehicle 10 that is to be operated is influenced in such a way that the actual distance for the distance X is increased in deviation from the predetermined setpoint distance.

It is thus within the scope of the present invention that, if it is found that the safety distance between the vehicle 12 driving behind the vehicle 10 that is to be operated and the latter vehicle becomes too small, the safety distance between the vehicle 10 that is to be operated and the vehicle 11 driving in front is increased.

According to an advantageous further embodiment of the present invention, the brake lights of the vehicle that is to be operated are activated automatically when the distance of the vehicle 10 that is to be operated from the vehicle 12 driving behind same drops below the specific limit value.

The brake lights are preferably activated before the speed drops below this limit value, namely when a certain hazard probability and/or a certain accident speed is deduced on the basis of the prevailing driving speed of the vehicle 10 that is to be operated as well as the distances X1 and X2 that are determined. It is possible in this way to give the driver of the vehicle 12 driving behind the vehicle 10 that is to be operated an opportunity to respond before the speed of the vehicle 10 that is to be operated is in fact reduced.

If it is later found that the distance X2 of the vehicle 10 that is to be operated from the vehicle 12 driving behind the vehicle 10 that is to be operated again exceeds the specific limit value for X2, then the system returns to the old setpoint distance for X1, which preferably depends on speed.

1. A method for operating a motor vehicle, which comprises the steps of:
detecting an actual distance of the motor vehicle being operated from a further vehicle driving in front of the motor vehicle being operated;
automatically influencing a speed of the motor vehicle being operated such that a predetermined setpoint distance is maintained;
detecting a further distance of the motor vehicle being operated from an additional vehicle driving behind the motor vehicle being operated; and
when the further distance of the motor vehicle being operated from the additional vehicle driving behind the motor vehicle being operated drops below a specific limit value, automatically increasing the predetermined setpoint distance of the motor vehicle being operated from the further vehicle driving in front of the motor vehicle being operated.

2. The method according to claim 1, which further comprises automatically activating brake lights of the motor vehicle being operated at a latest when the further distance of the motor vehicle being operated from the additional vehicle driving behind the motor vehicle being operated drops below the specific limit value.

3. The method according to claim 2, which further comprises already automatically activating the brake lights in advance on detection of a certain probability of danger.

4. A method for operating a motor vehicle, which comprises the steps of:
detecting an actual distance between the motor vehicle being operated and a further vehicle driving in front of the motor vehicle being operated;
automatically influencing a speed of the motor vehicle being operated such that a predetermined setpoint distance is maintained;
detecting a further distance between the motor vehicle being operated and an additional vehicle driving behind the motor vehicle being operated; and
if the further distance of the motor vehicle being operated from the additional vehicle driving behind the motor vehicle being operated drops below a specific limit value, automatically influencing the speed of the motor vehicle being operated such that the actual distance is increased in deviation from the predetermined setpoint distance.

5. The method according to claim 4, which further comprises automatically activating brake lights of the motor vehicle being operated at a latest when the further distance of the motor vehicle being operated from the additional vehicle driving behind the motor vehicle being operated drops below the specific limit value.

6. The method according to claim 5, which further comprises already automatically activating the brake lights in advance on detection of a certain probability of danger.
